(19) United States
(12) Patent Application Publication
(10) Pub. No.: US 2016/0318687 A1
(43) Pub. Date: Nov. 3, 2016

(54) Container Comprising A Treatment Agent And Method For The Production Thereof

(71) Applicant: SANNER GMBH, Bensheim (DE)

(72) Inventor: Matthias Schneider, Heidesheim (DE)

(21) Appl. No.: 15/107,609

(22) PCT Filed: Dec. 11, 2014
(86) PCT No.: PCT/EP2014/077432

§ 371 Date: Jun. 23, 2016

(30) Foreign Application Priority Data
Dec. 23, 2013 (DE) 10 2013 114 772.0

(51) Int. Cl. B65D 81/26; B01D 53/04; B65D 8/00; B01D 53/26; A61J 1/03; B65D 6/08

(52) U.S. Cl. CPC B65D 81/268; A61J 1/03; B65D 11/14; B65D 11/02; B01D 53/261; B01D 53/0415

(57) ABSTRACT

Container having a wall (2) which forms a receiving space (3) and is delimited from a surrounding area (4), wherein a treatment agent, in particular a desiccant, is received in the receiving space (3). The wall (2) comprises a lattice (5, 5′) having lattice openings (6), through which the treatment agent can come into contact with a substance in the surrounding area (4). The lattice (5, 5′) has first and second lattice sides, wherein the first lattice side (11) is formed by a first layered lattice portion (13) and the second lattice side (12) is formed by a second layered lattice portion (14). First linear recesses (15) are formed in the first lattice side (11), and second linear recesses (16) are formed in the second lattice side (12). The first and second linear recesses (15, 16) intersect at intersection regions, wherein the lattice openings (6) are formed in the intersection regions of the first and second recesses (15, 16). The second linear recesses (16) are not arranged in parallel with one another.

The present invention relates to a container having a wall which forms a receiving space and is delimited from a surrounding area, wherein a treatment agent, in particular a desiccant, is received in the receiving space, wherein the wall comprises a lattice which is provided with lattice openings, through which the treatment agent can come into contact with a substance from the surrounding area, wherein the lattice is a synthetic material injection-moulded part and wherein the lattice has a first and a second lattice side, wherein the first lattice side is formed by a first layered lattice portion and the second lattice side is formed by a second layered lattice portion, wherein first linear recesses are formed in the first lattice side, wherein second linear recesses are formed in the second lattice side, wherein the first and second linear recesses intersect at intersection regions and wherein the lattice openings are formed in the intersection regions of the first and second recesses. Such a body can be formed e.g. as a desiccant capsule. In this case, a desiccant, such as e.g. silica gel, is received in the receiving space as the treatment agent. By means of the lattice openings, the desiccant in the receiving space can come into contact with the air (or another gas) from the area surrounding the body and can bind moisture occurring in the surrounding area. In this manner, e.g. the interior of a package, in which the container is located, can be kept dry. At the same time, the lattice prevents the treatment agent from exiting the body. The invention also relates to a method for producing such a container.

Containers for receiving a desiccant hitherto mostly comprised a receiving space which is provided on one side with a cover consisting of cardboard. The pores in the cardboard allow moisture to be exchanged with the surrounding area. At the same time, the cardboard prevents the desiccant from exiting.

However, the disadvantage of covers consisting of cardboard is that a considerable amount of waste is produced when the mostly round covers consisting of cardboard are punched out. Moreover, covers consisting of cardboard are not dimensionally stable.

Furthermore, it has already been proposed to manufacture the lattice from synthetic material. Such a container for a treatment agent is known from U.S. Pat. No. 4,093,105. The aforementioned container comprises openings, which are larger in the region of the inner surface of the container and are smaller on the outer surface.

A further container for a treatment agent comprising a lattice consisting of synthetic material is known from U.S. Pat. No. 5,730,785. In order to prevent desiccant from exiting, the openings have a diameter which increases from the inside outwards.

The aforementioned containers comprising a lattice consisting of synthetic material have the disadvantage that the tools used in production by means of injection-moulding have to be formed in a very delicate manner in order to form the small lattice openings. Therefore, the tools become rapidly worn during production. By reason of the wear on the tool, the lattice openings become undesirably smaller with increasing number of shots of the tool. The quality of the exchange between the treatment agent and the surrounding area can suffer as a result of this. Moreover, the production costs are increased.

DE 10 2004 002 963 A1 already describes a lattice structure which comprises two groups of parallel ribs, of which the ribs of one group extend at a right angle to the ribs of the other group.

In contrast, the object of the invention is to provide a container, which can be produced simply and reliably.

This object is achieved by the features of claim 1. Accordingly, in the case of a container mentioned in the introduction, provision is made that the second linear recesses are not arranged in parallel with one another. This configuration allows the container to be produced in a simple and reliable manner. In particular, effective filling behaviour of the injection mould is thereby achieved during production. Moreover, the lattice can be produced with good precision. In particular, the tools become worn only to a low degree during production and therefore production can also be performed without any problems over a longer period of time. Moreover, the production is cost-effective. Further advantages of the configuration are that the lattice comprises a high level of stability. Therefore, it is possible to fill the container—depending upon the application—with a different amount of treatment agent. By reason of the high level of stability, no additional measures are required which would make production more complicated and more expensive.

According to one advantageous development of the invention, provision is made that the second linear recesses are arranged in a star-shaped manner about a central portion. This further improves production. In particular, this configuration once again improves the filling behaviour of the injection mould used in production. Preferably, the linear recesses are each arranged in a radial direction. Furthermore, this arrangement also contributes to an effective level of stability of the lattice.

In a further preferred embodiment, provision is made that the first layered lattice portion comprises first lattice bars which are defined by the first linear recesses, and that the second layered lattice portion comprises second lattice bars which are defined by the second linear recesses. First and second lattice bars intersect, wherein the lattice openings are arranged between the intersection regions of the first and second lattice bars. Such a configuration can be produced simply and reliably.

A further improvement can be achieved by virtue of the fact that the first lattice bars extend in a circumferential direction and/or that the second lattice bars extend in a radial direction. This permits not only reliable production but also contributes to a high level of stability of the lattice.

In accordance with the invention, it is particularly advantageous if the first lattice bars are formed in an annular or partially annular manner. In addition, the first recesses can also be formed in an annular or partially annular manner. Preferably, the first lattice bars can extend along a round line e.g. in a circular manner.

According to one advantageous embodiment of the invention, provision is made that the second linear recesses comprise different lengths, wherein one or a plurality of shorter ones of the second recesses are arranged between two longer ones of the second recesses. In this case, the second lattice bars can form a main limb and branches with sub-limbs, wherein the main limbs are separated by the longer ones of the second recesses and wherein the sub-limbs are separated by the shorter ones of the second recesses. Preferably, one to three, particularly preferably two, sub-limbs are provided on each branch. This configuration further improves production. In this case, this arrangement of the second linear recesses permits a particularly effective filling behaviour of the injection mould during production by injection-moulding. In one advantageous development of this inventive concept, provision is made that the shorter ones of the second recesses have a larger spaced interval from a central region of the lattice than the longer ones of the second recesses.

A particularly effective production capability is achieved in an advantageous manner when the first lattice portion comprises, in a central region, webs, which extend in a radial direction. The webs contribute to an effective filling behaviour of the injection mould during production of the lattice. This applies particularly when the first lattice bars extend in a circumferential direction. The webs can preferably be arranged in a star-shaped manner.

In accordance with the invention, it is particularly preferred that the lattice openings have an inner width between 0.1 mm and 0.25 mm.

Furthermore, provision can also be made in an advantageous manner that the lattice openings comprise a plurality of sides. In this case, in particular at least one of the sides can be curved. Preferably, two of the sides are curved. In this case, two of the sides can be formed by the first lattice bars and two further ones of the sides can be formed by the second lattice bars. Curved sides can be formed preferably by annular first lattice bars.

In an advantageous embodiment of the invention, provision is made that the first linear recesses are open towards the surrounding area and the second linear recesses are open towards the receiving space, or that the first linear recesses are open towards the receiving space and the second linear recesses are open towards the surrounding area.

In accordance with the invention, it is particularly preferred if the body is formed as a capsule, in particular as a desiccant capsule. The capsule can be a separate part which is arranged e.g. in a package. Furthermore, the capsule can also be part of the package and can be integrated e.g. into a top cover, in particular a stopper.

The invention also relates to a closable package comprising a closed space for goods to be packaged, in particular tablets, wherein at least one container, in accordance with the invention, is arranged in the space for the goods to be packaged.

The object of the invention is also to provide a method for producing a container in accordance with the invention—a method, which can be performed simply, reliably and cost-effectively. This object is achieved by a method as claimed in claim 14. Accordingly, a method for producing a container in accordance with the invention by injection-moulding is provided, wherein the first recesses are formed by a first injection-moulding tool portion and the second recesses are formed by a second injection-moulding tool portion separate therefrom. It is particularly preferred if the first and second injection-moulding tool portions are moved relative to one another during demoulding.

An effective production capability is achieved when an injection point is arranged on the second lattice portion. In an advantageous manner, the injection point can be arranged in a central region. This contributes to reliable production and an effective filling behaviour of the injection mould.

Further objectives, features, advantages and possible applications of the present invention will be apparent from the description hereinafter of exemplified embodiments with reference to the drawing. All of the described and/or figuratively illustrated features form the subject matter of the invention in their own right or in any meaningful combination, even irrespective of the combination in individual claims or dependency references thereof.

In the drawing:

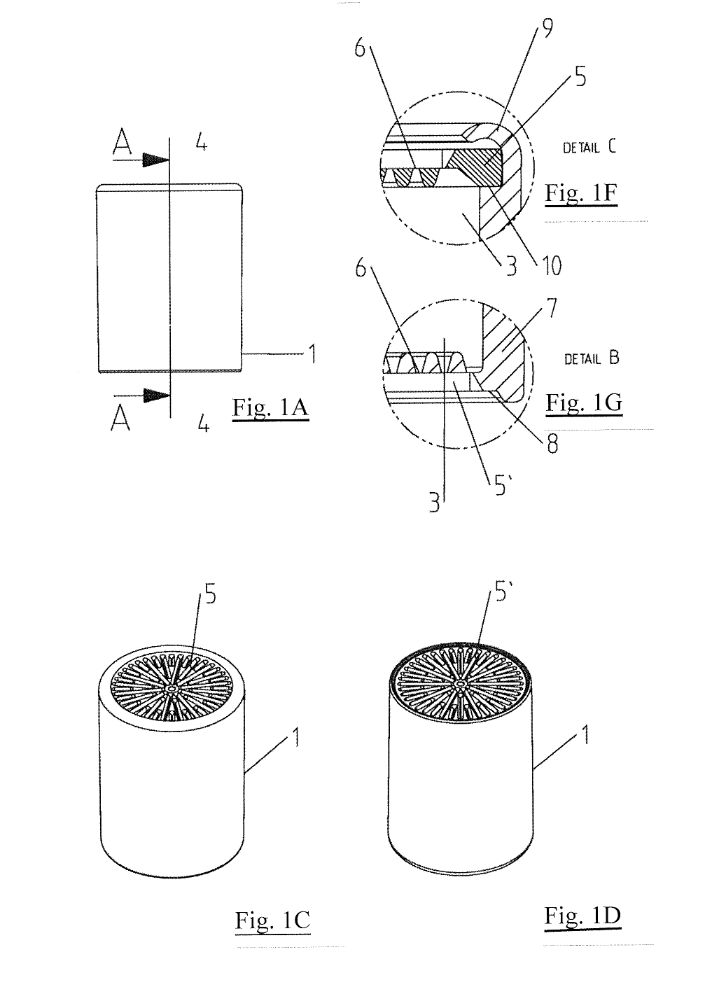

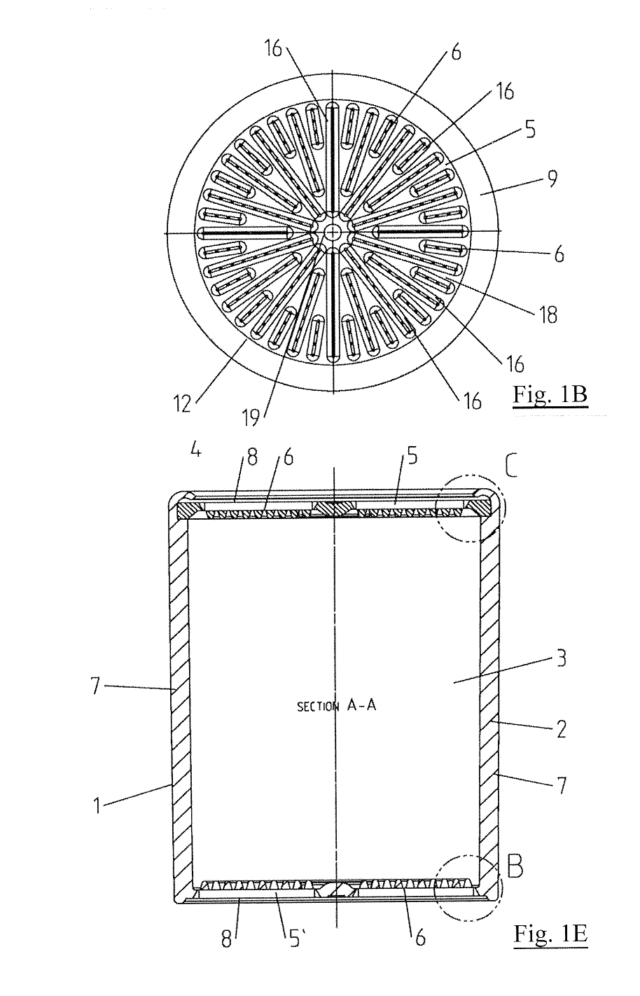

FIG. 1a: shows a side view of a container in accordance with the invention;

FIG. 1b: shows a view of the container of FIG. 1a from above;

FIG. 1c: shows a perspective view of the container of FIG. 1a from above;

FIG. 1d: shows a perspective view of the container of FIG. 1a from below;

FIG. 1e: shows a transverse section through the container of FIG. 1a along line A-A;

FIG. 1f: shows the enlarged detail C of the container of FIG. 1e;

FIG. 1g: shows the enlarged detail D of the container of FIG. 1e;

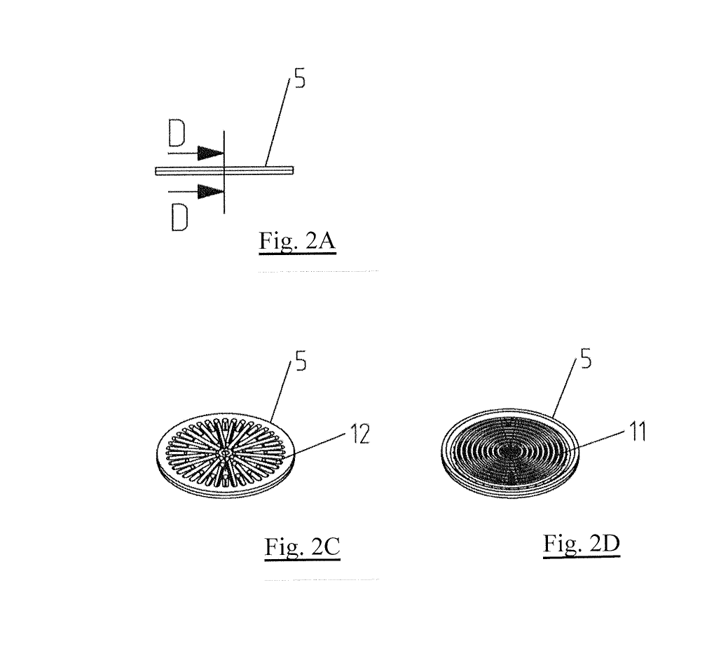

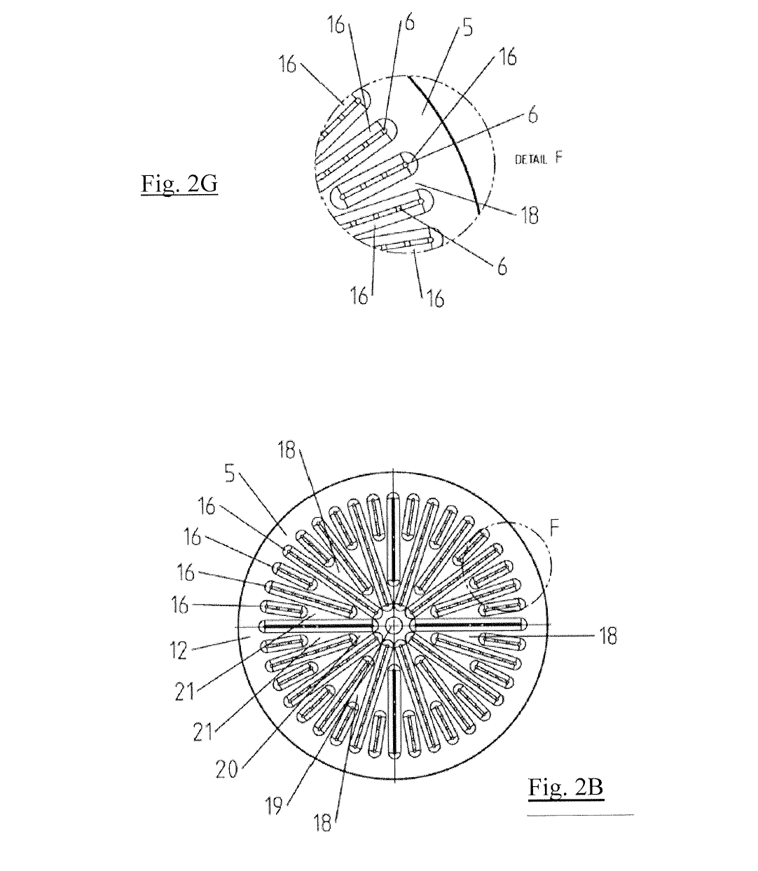

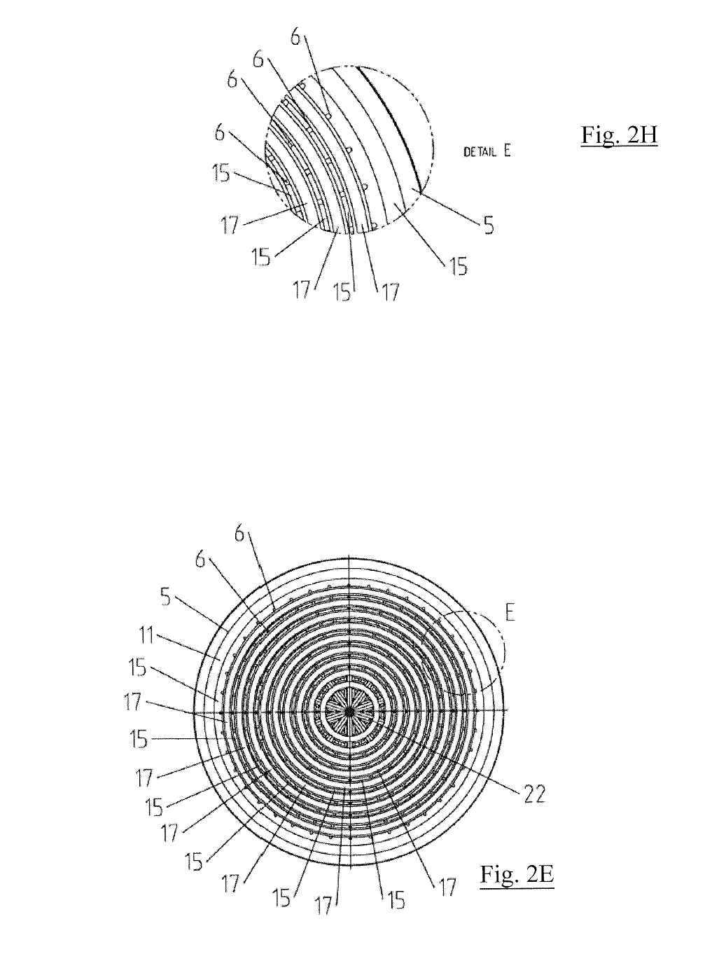

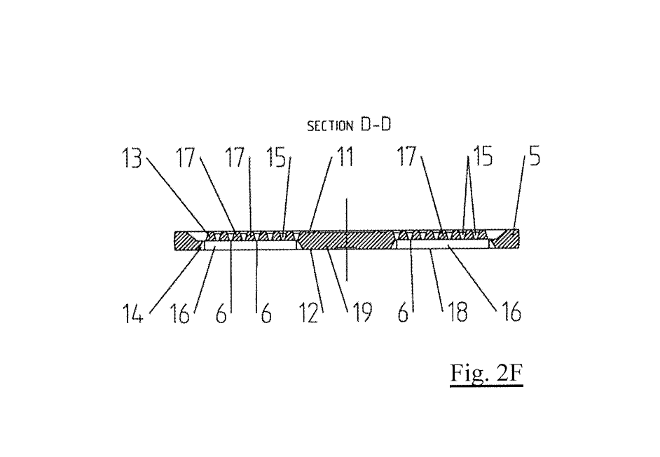

FIG. 2a: shows a side view of a lattice in accordance with the invention;

FIG. 2b: shows a view of the lattice of FIG. 2a with an enlarged detail from above;

FIG. 2c: shows a perspective view of the lattice of FIG. 2a from above;

FIG. 2d: shows a perspective view of the lattice of FIG. 2a from below;

FIG. 2e: shows a view of the lattice of FIG. 2a with an enlarged detail from below;

FIG. 2f: shows a transverse section through the lattice of FIG. 2a along line D-D;

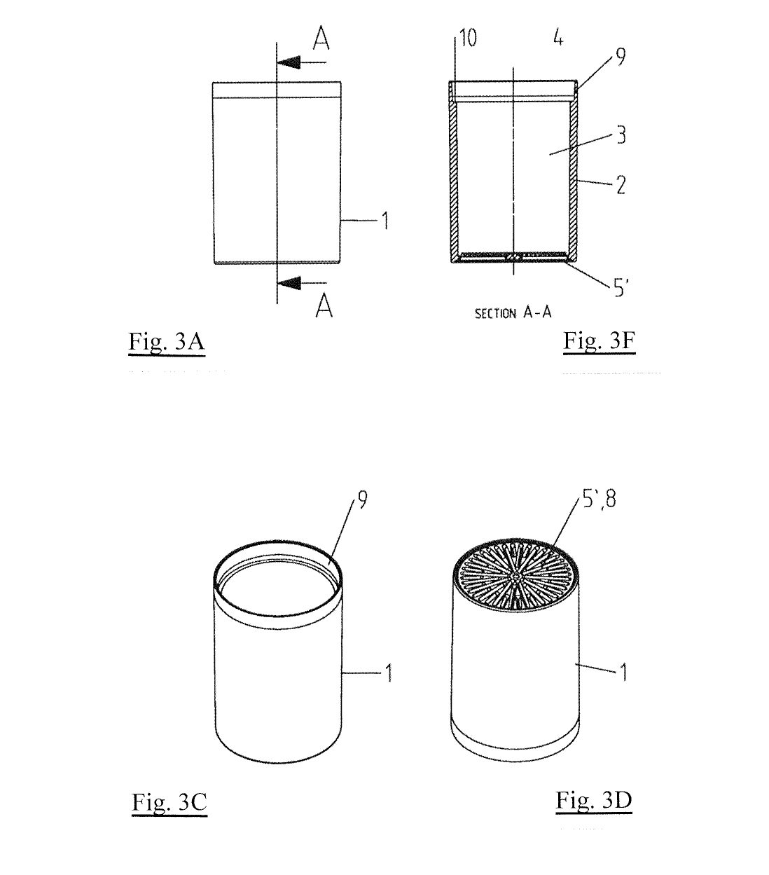

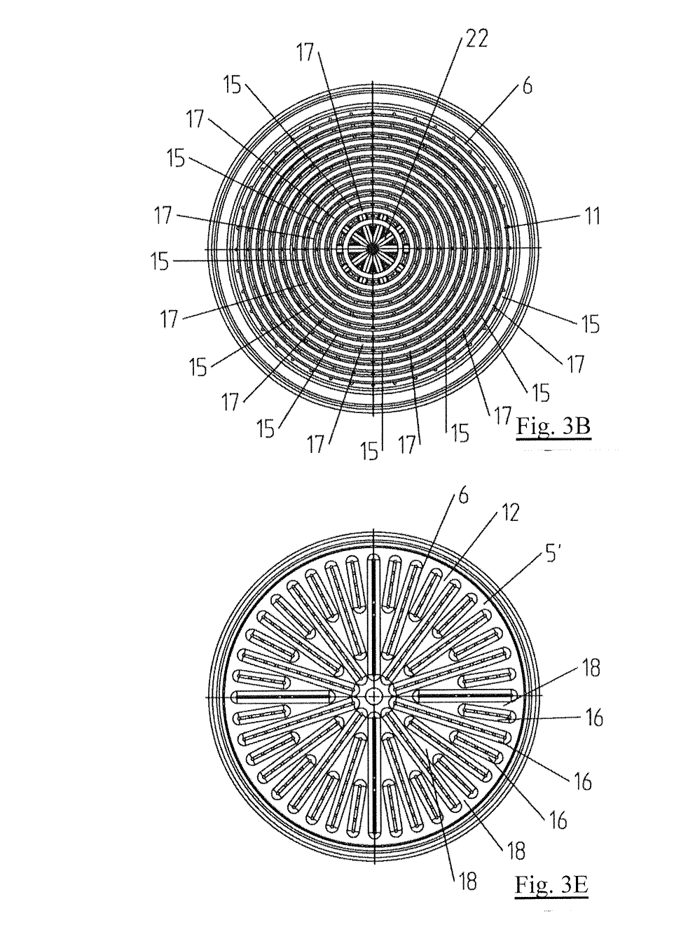

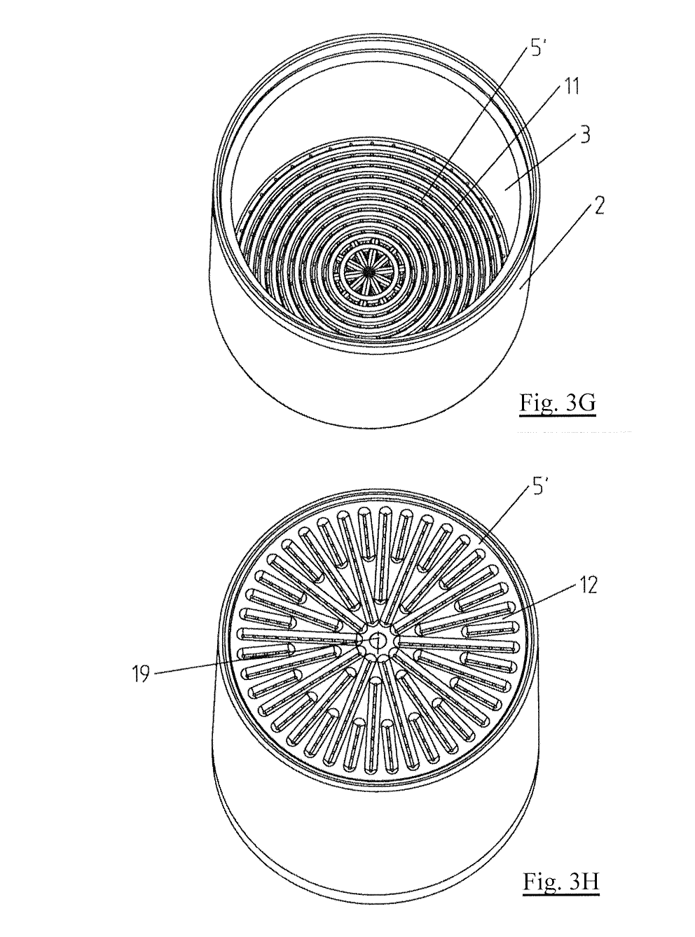

FIG. 3a: shows a side view of the container of FIG. 1a without a lattice;

FIG. 3b: shows a view of the container of FIG. 3a from above;

FIG. 3c: shows a perspective view of the container of FIG. 3a from above;

FIG. 3d: shows a perspective view of the container of FIG. 3a from below;

FIG. 3e: shows a view of the container of FIG. 3a from below;

FIG. 3f: shows a transverse section through the container of FIG. 3a along line A-A;

FIG. 3g: shows a further perspective view of the container of FIG. 3a from above;

FIG. 3h: shows a further perspective view of the container of FIG. 3a from below.

FIGS. 1a to 1e illustrate a container 1. As can be seen particularly in FIG. 1e, the container comprises a wall 2, which forms a receiving space 3. The receiving space 3 is surrounded by the wall 2 and is delimited from the surrounding area 4. A treatment agent, not illustrated, can be received in the receiving space 3. The container is particularly suitable for a desiccant, such as e.g. silica gel, which can bind moisture. The wall 2 comprises a side portion 7. In the illustrated exemplified embodiment, the side section is formed in a cylindrical manner. Furthermore, the wall 2 comprises end portions 8 on opposite sides.

In order to ensure that the treatment agent can come into contact with the surrounding area 4, the wall 2 comprises lattices 5, 5′. In the illustrated exemplified embodiment, the container I comprises in each case a lattice 5 or 5′ on the opposite sides. The lattice 5, 5′ is provided in each case with lattice openings 6, which connect the receiving space 3 to the surrounding area 4. The lattices 5, 5′ are arranged in the end portions 8 of the wall 2.

The container 1 is formed as an injection-moulded part. In the illustrated exemplified embodiment, the lattice 5′ is connected in one piece to the side portion 7 of the wall 2. The lattice 5 is a separate injection-moulded part which is inserted after the container 1 has been filled with the treatment agent. In order to fix the lattice 5, the side portion 7 comprises, in the wall 2, a clamping portion 9, which fixes the lattice 5. This can be seen particularly clearly in FIG. 1f. This figure illustrates that the side portion 7 forms a shoulder 10 on which the lattice 5 is arranged. The clamping portion 9 is a bent edge of the side portion 7. The lattice 5 is fixed between the clamping portion 9 and the shoulder 10.

It can also be seen in FIGS. 1a to 1e that the container 1 is formed as a capsule. If the container is filled with a desiccant, a desiccant capsule is produced. The desiccant capsule is typically filled with an amount between 0.2 g and 10 g of desiccant, preferably with an amount between 0.5 g and 3 g of desiccant. The desiccant capsule can be introduced into a closable package, such as e.g. a synthetic material container having a closure and comprising a space for goods to be packaged, such as e.g. tablets. In this manner, the desiccant capsule can ensure constant dry conditions in the interior of the package. Contrary to the illustration, the container can also be integrated into the closure of a closable package. For example, the container can be arranged on a stopper, e.g. on a tablet tube. In this case, it is preferred to provide only one lattice, which is arranged on the side of the container which protrudes into the space for the goods to be packaged.

FIGS. 2a to 2d show the lattice 5 of the container 1 illustrated in FIGS. 1a to 1e. Apart from the fact that the lattice 5′ is not manufactured as a separate component, it is formed substantially identical to the lattice 5. Therefore, the following description of the lattice 5 also applies accordingly to the lattice 5′.

The lattice 5 has a first lattice side 11 and a second lattice side 12. The first lattice side 11 is formed by a first layered lattice portion 13. The second lattice side 12 is formed by a second layered lattice portion 14. The first and second layered lattice portion 13, 14 are interconnected and are configured as a unitary injection-moulded part. The first linear recesses 15, which are open towards the receiving space 3 are formed in the first lattice side 11. The second linear recesses 16, which are open towards the surrounding area 4 are provided in the second lattice side 12. In this case, first lattice bars 17 are formed in the first layered lattice portion 13. The first lattice bars 17 are defined laterally by the first linear recesses 15. The second layered lattice portion 14 comprises second lattice bars 18. These are defined laterally by the second linear recesses 16.

It can also be seen in the figures that the first linear recesses 15 and the second linear recesses 16 intersect at intersection regions, wherein lattice openings 6 are formed in the intersection regions of the first and second recesses 15, 16.

The arrangement of the first and second linear recesses 15 and 16 can be seen particularly clearly in FIGS. 2b and 2e. It is apparent here that the first linear recesses 15 extend in a circumferential direction. In the illustrated exemplified embodiment, the first linear recesses 15 are formed in a circular manner. Accordingly, the first lattice bars 17 also extend in a circumferential direction and are formed in a circular manner in the illustrated exemplified embodiment. In contrast, the second linear recesses 16 and the second lattice bars 18 are arranged in a star-shaped manner about the central region 19 of the lattice 5. The illustrated exemplified embodiment shows that the second linear recesses 16 are not arranged in parallel with one another. Accordingly, the second lattice bars 18 are also not arranged in parallel with one another. The recesses 16 each extend in a radial direction. This can be seen in FIG. 2b. It is apparent here that in the illustrated exemplified embodiment the second linear recesses 16 extend precisely in a radial direction. The lattice openings 6 are formed in the intersection regions of the second linear recesses 16, extending in a radial direction, and of the first linear recesses 15, extending in a circumferential direction.

It can also be seen in FIG. 2b that the second linear recesses 16 comprise different lengths. In the illustrated exemplified embodiment, the second linear recesses 16 comprise three different lengths. In each case one or a plurality of shorter second recesses 16 are arranged between two longer ones of the second recesses 16. The shorter ones of the second recesses 16 have a larger spaced interval from a central region 19 of the lattice 5 than the longer ones of the second recesses 16. In this manner, the second lattice bars 18 each form a main limb 20, which originates from the central region 19. The main limbs 20 are separated by the longer ones of the second recesses 16. Each main limb 20 comprises a plurality of sub-limbs 21 which are separated by the shorter ones of the second recesses 16.

The lattice openings 6 comprise an inner width between 0.1 mm and 0.25 mm. Moreover, the lattice openings 6 each comprise a plurality of sides. In the illustrated exemplified embodiment, each lattice opening 6 comprises four sides. Two sides are defined by the first lattice bars 17 and two further sides are defined by the second lattice bars 18. Since the first lattice bars 17 are curved, two sides of the lattice openings 6 are also curved.

It can also be seen in FIG. 2b that the second linear recesses 16 and the second lattice bars 18 are formed in a star-shaped manner.

An injection point is arranged in the central region 19 of the second lattice portion 14. In this mariner, during the injection-moulding procedure the liquid synthetic material can be guided radially outwards in the first lattice bars 17. At the same time, the second lattice bars 18 are filled.

It can be seen in FIG. 2e that the first lattice portion 13 comprises, in a central region, webs 22, which extend in a radial direction.

During the injection-moulding, the first recesses 15 are formed by a first injection-moulding tool portion and the second recesses 16 are formed by a second injection-moulding tool portion (not illustrated). For forming purposes, the first and second injection-moulding tool portions are moved relative to one another.

FIGS. 3a to 3h show the container I without the lattice 5. Again, it can be clearly seen that the container 1 comprises a wall having a side portion 7. An end portion 8 of the wall 2 is formed by the lattice 5′. The shoulder 10 on which the lattice 5 can be arranged can also be clearly seen. It can also be seen that the clamping portion 9 is located initially in the extension of the side portion 7 before it is moved to the clamping position illustrated in FIG. 1f after insertion of the lattice 5. Furthermore, FIGS. 3a to 3h clearly show the lattice 5′ once again. Apart from the fact that said lattice 5′ is formed in one piece with the side portion 7 of the wall 2, it is configured in precisely the same way as the above-described lattice 5.

1. A container comprising:
a wall which forms a receiving space delimited from a surrounding area,
wherein a treatment agent, in particular a desiccant, is received in the receiving space,
wherein the wall comprises a lattice which is provided with lattice openings, through which the treatment agent can come into contact with a substance in the surrounding area,
wherein the lattice is a synthetic material injection-moulded part, wherein the lattice has a first and a second lattice side,
wherein the first lattice side is formed by a first layered lattice portion and the second lattice side is formed by a second layered lattice portion,
wherein first linear recesses are formed in the first lattice side and second linear recesses are formed in the second lattice side,
wherein the first and second linear recesses intersect at intersection regions, wherein the lattice openings are formed in the intersection regions of the first and second recesses,
wherein the second linear recesses are not arranged in parallel with one another.

2. The container as claimed in claim 1, wherein the second linear recesses are arranged in a star-shaped manner about a central portion.

3. The container as claimed in claim 1, wherein the first layered lattice portion comprises first lattice bars which are defined by the first linear recesses, and in that the second layered lattice portion comprises second lattice bars which are defined by the second linear recesses.

4. The container as claimed in claim 3, wherein the first lattice bars extend in a circumferential direction and/or in that the second lattice bars extend in a radial direction.

5. The container as claimed in claim 3, wherein the first lattice bars are formed in an annular and/or partial annular manner.

6. The container as claimed in claim 1, wherein the second linear recesses have different lengths, wherein one or a plurality of shorter ones of the second recesses are arranged between two longer ones of the second recesses.

7. The container as claimed in claim 6, wherein the shorter ones of the second recesses have a larger spaced interval from a central region of the lattice than the longer ones of the second recesses.

8. The container as claimed in claim 1, wherein the first lattice portion comprises, in a central region, webs which extend in a radial direction.

9. The container as claimed in claim 1, wherein the lattice openings have an inner width between 0.1 mm and 0.25 mm.

10. The container as claimed in claim 1, wherein the lattice openings comprise a plurality of sides, wherein in particular at least one of the sides is curved.

11. The container as claimed in claim 1, wherein the first linear recesses are open towards the surrounding area and the second linear recesses are open towards the receiving space, or in that the first linear recesses are open towards the receiving space and the second linear recesses are open towards the surrounding area.

12. The container as claimed in claim 1, wherein the container is formed as a capsule, in particular as a desiccant capsule.

13. A closable package comprising a space for goods to be packaged, in particular tablets, wherein the container as claimed in claim 1 is arranged in the space for the goods to be packaged.

14. A method for producing the container as claimed in claim 1 comprising injection-moulding the container, wherein the first recesses are formed by a first injection-moulding tool portion and the second recesses are formed by a second injection-moulding tool portion separate therefrom.

15. The method as claimed in claim 14, wherein an injection point is formed on the second lattice portion.

16. The container as claimed in claim 2, wherein the first layered lattice portion comprises first lattice bars which are defined by the first linear recesses, and in that the second layered lattice portion comprises second lattice bars which are defined by the second linear recesses.

17. The container as claimed in claim 16, wherein the first lattice bars extend in a circumferential direction and/or in that the second lattice bars extend in a radial direction.

18. The container as claimed in claim 2, wherein the second linear recesses have different lengths, wherein one or a plurality of shorter ones of the second recesses are arranged between two longer ones of the second recesses.

19. The container as claimed in claim 18, wherein the shorter ones of the second recesses have a larger spaced interval from a central region of the lattice than the longer ones of the second recesses.

20. The container as claimed in claim 2, wherein the first lattice portion comprises, in a central region, webs which extend in a radial direction.
